(19) United States
(12) Patent Application Publication
(10) Pub. No.: US 2018/0002957 A1
(43) Pub. Date: Jan. 4, 2018

(54) DOOR HINGE

(71) Applicant: Jae Sun KU, Gwangju (KR)

(72) Inventor: Jae Sun KU, Gwangju (KR)

(21) Appl. No.: 15/538,648

(22) PCT Filed: Jan. 4, 2016
(86) PCT No.: PCT/KR2016/000002

§ 371 Date: Jun. 21, 2017

(30) Foreign Application Priority Data
Jan. 6, 2015 (KR) 10-2015-0001311

(51) Int. Cl. E05D 3/18; E05D 7/04

(52) U.S. Cl. CPC E05D 3/186; E05D 7/04; E05Y 2900/132; E05Y 2600/41

(57) ABSTRACT

The present invention relates to a door hinge including: a fixed part having a body formed in an angular pipe shape of at least a triangle or more, a rack gear disposed parallel to the body on one side inner surface of the body, and an insertion hole formed on the side portion of the body in such a manner as to communicate with the interior of the body; and an operating part having a rotary shaft, a pinion gear disposed on the outer peripheral surface of the rotary shaft in such a manner as to correspond to the rack gear, and a moving piece protruding outwardly from the outer peripheral surface of the rotary shaft, wherein the rotary shaft is inserted into the insertion hole in such a manner as to allow the moving piece to outwardly protrude from the door hinge, and the moving piece rotates around the rotary shaft, so that the rotary shaft moves along the rack gear.

### TECHNICAL FIELD

The present invention relates to a door hinge, and more particularly, to a door hinge that is configured and installed on a door, without being protrudingly exposed to the outside of the door.

### BACKGROUND ART

Generally, a door hinge is mounted on a door to rotate the door so that the door is open and closed, and in this case, two fixed plates are rotatably coupled to each other by means of a shaft. That is, one side fixed plate is fixed to the door, and the other side fixed plate to a door frame.

Recently, furniture having a simple design is more popular among consumers than that having a brilliant design, and accordingly, hinges are also installed inside the furniture, without being exposed to the outside. Such hinges are widely used on places such as sink tables, furniture, and the like.

In addition to the door hinges used to open the door erected vertically to left and right sides, further, they are used to unfold vertically or horizontally folded door to an opposite side to the folded side.

However, if a door is installed using the conventional door hinge, the shaft fixing the two fixed plates is protrudingly exposed to the outside of the door, which undesirably makes the outer appearance of the door look bad and causes an object or people to damagedly collide against the outwardly protruding portion of the door hinge.

### DISCLOSURE

### Technical Problem

Accordingly, the present invention has been made in view of the above-mentioned problems occurring in the prior art, and it is an object of the present invention to provide a door hinge that is configured wherein a rack gear and a pinion gear are provided to allow a rotary shaft to move in one side direction while rotating, so that the door hinge can perform the function as the hinge, without any outwardly protruding portion therefrom.

### Technical Solution

To accomplish the above-mentioned object, according to the present invention, there is provided a door hinge including: a fixed part having a body formed in an angular pipe shape of at least a triangle or more, a rack gear disposed parallel to the body on one side inner surface of the body, and an insertion hole formed on the side portion of the body in such a manner as to communicate with the interior of the body; and an operating part having a rotary shaft, a pinion gear disposed on the outer peripheral surface of the rotary shaft in such a manner as to correspond to the rack gear, and a moving piece protruding outwardly from the outer peripheral surface of the rotary shaft, wherein the rotary shaft is inserted into the insertion hole in such a manner as to allow the moving piece to outwardly protrude from the door hinge, and the moving piece rotates around the rotary shaft, so that the rotary shaft moves along the rack gear.

According to the present invention, desirably, the pinion gear is disposed on a quarter of the outer peripheral surface of the rotary shaft, so that the rotating radius of the moving piece around the rotary shaft is limited to an angle of 90°.

According to the present invention, desirably, bearings are coupled in the interior of the body to the top and bottom ends of the rotary shaft so as to fix the rotary shaft inserted into the interior of the body through the insertion hole to prevent the rotary shaft from being deviated from the interior of the body and so as to guide the rotary shaft moving.

According to the present invention, desirably, another operating part and another fixed part are disposed on the other side end portion of the moving piece in a symmetrical relation with the operating part and the fixed part disposed on one side end portion of the moving piece, so that the rotating radius of another fixed part disposed symmetrically with the fixed part is increased.

### Advantageous Effects

As mentioned above, the door hinge according to the present invention is configured wherein the fixed part and the operating part are fixed to each other by means of the bearings, so that the door hinge is simple in configuration and easy in installation.

Further, the door hinge according to the present invention is configured wherein the fixed part and the operating part are made in large quantities by means of injection molding using molds, thereby obtaining economical advantages, and wherein no outwardly protruding portion therefrom exists, thereby desirably making the outer appearance of the door look good when the door hinge is installed and preventing an object or people from damagedly colliding against the protruding portion of the door hinge.

### DESCRIPTION OF DRAWINGS

FIG. 1 is a perspective view showing the outer appearance of a door hinge according to a first embodiment of the present invention.

FIG. 2 is a perspective view showing the coupling process of the door hinge according to the first embodiment of the present invention.

FIG. 3 is a sectional view showing the door hinge according to the first embodiment of the present invention.

FIG. 4 is a sectional view showing the state wherein the moving piece rotates in the door hinge according to the first embodiment of the present invention.

FIG. 5 is a perspective view showing the outer appearance of a door hinge according to a second embodiment of the present invention.

FIG. 6 is a perspective view showing the coupling process of the door hinge according to the second embodiment of the present invention.

FIG. 7 is a sectional view showing the door hinge according to the second embodiment of the present invention.

FIG. 8 is a sectional view showing the state wherein a first operating part rotates in the door hinge according to the second embodiment of the present invention.

FIG. 9 is a sectional view showing the state wherein a second fixed part rotates in the door hinge according to the second embodiment of the present invention.

### BEST MODE FOR INVENTION

Hereinafter, an explanation on a door hinge according to preferred embodiments of the present invention will be in detail given with reference to the attached drawings.

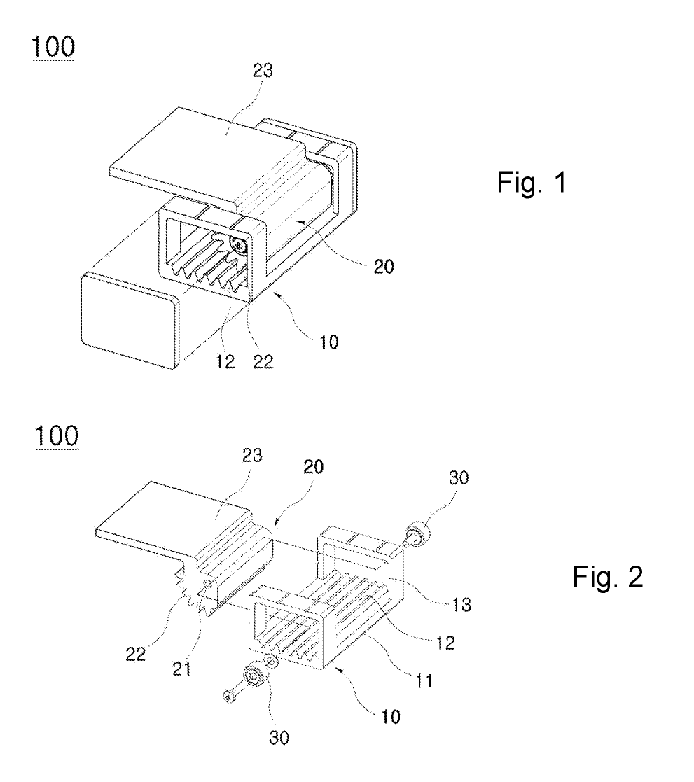

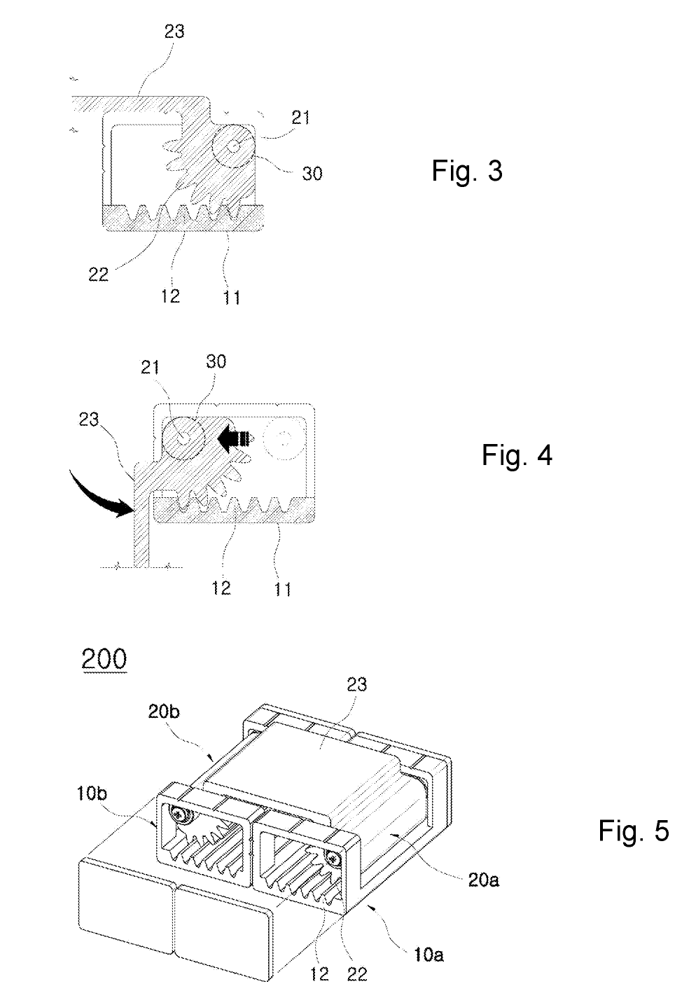

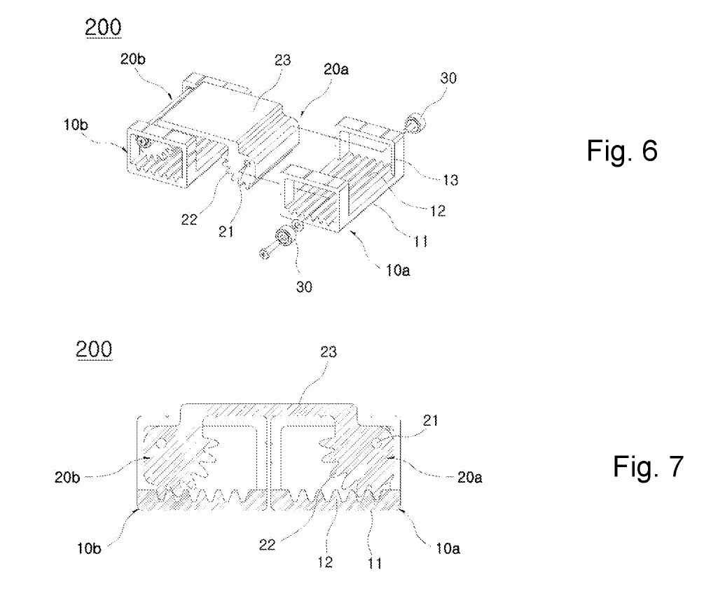

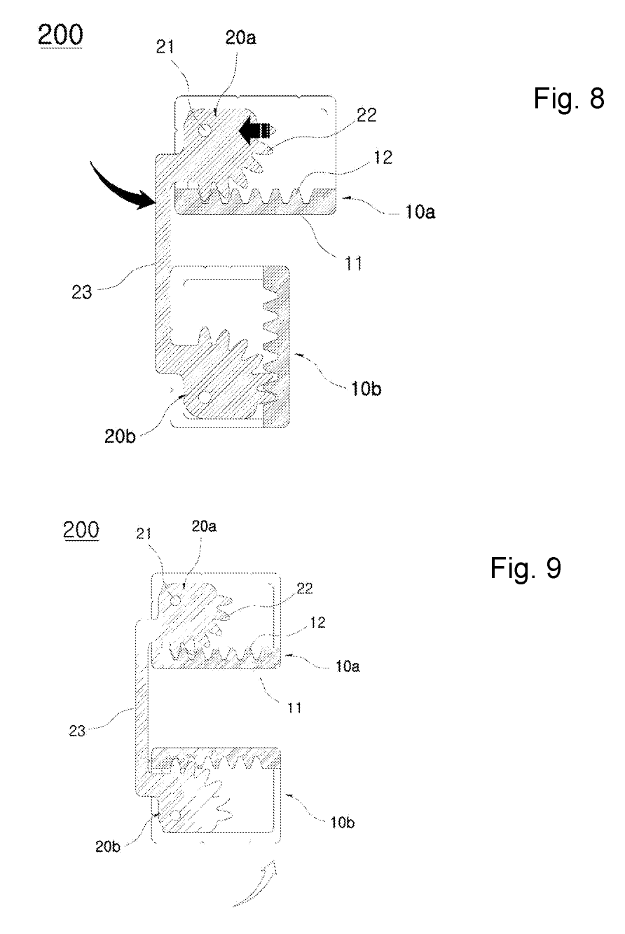

FIG. 1 is a perspective view showing the outer appearance of a door hinge according to a first embodiment of the present invention, FIG. 2 is a perspective view showing the coupling process of the door hinge according to the first embodiment of the present invention, FIG. 3 is a sectional view showing the door hinge according to the first embodiment of the present invention, FIG. 4 is a sectional view showing the state wherein the moving piece rotates in the door hinge according to the first embodiment of the present invention, FIG. 5 is a perspective view showing the outer appearance of a door hinge according to a second embodiment of the present invention, FIG. 6 is a perspective view showing the coupling process of the door hinge according to the second embodiment of the present invention, FIG. 7 is a sectional view showing the door hinge according to the second embodiment of the present invention, FIG. 8 is a sectional view showing the state wherein a first operating part rotates in the door hinge according to the second embodiment of the present invention, and FIG. 9 is a sectional view showing the state wherein a second fixed part rotates in the door hinge according to the second embodiment of the present invention.

As shown in FIGS. 1 and 2, a door hinge 100 according to a first embodiment of the present invention basically includes a fixed part 10 and an operating part 20 rotatingly inserted into the side of the fixed part 10.

In more detail, the door hinge 100 according to the first embodiment of the present invention includes: the fixed part 10 having a body 11 formed in an angular pipe shape of at least a triangle or more, a rack gear 12 disposed parallel to the body 11 on one side inner surface of the body 11, and an insertion hole 13 formed on the side portion of the body 11 in such a manner as to communicate with the interior of the body 11; and the operating part 20 having a rotary shaft 21, a pinion gear 22 disposed on the outer peripheral surface of the rotary shaft 21 in such a manner as to correspond to the rack gear 12, and a moving piece 23 protruding outwardly from the outer peripheral surface of the rotary shaft 21, wherein the rotary shaft 21 is inserted into the insertion hole 13 in such a manner as to allow the moving piece 23 to outwardly protrude from the door hinge, and the moving piece 23 rotates around the rotary shaft 21, so that the rotary shaft 21 moves along the rack gear 12.

The fixed part 10 has the body 11 formed in an angular pipe shape of at least a triangle or more, the rack gear 12 disposed parallel to the body 11 on one side inner surface of the body 11, and the insertion hole 13 formed on the side portion of the body 11 in such a manner as to communicate with the interior of the body 11.

The body 11 is formed in an angular pipe shape of at least a triangle or more and is fixed to one side of a door frame. Desirably, the body 11 is formed in a rectangular pipe shape.

The rack gear 12 is disposed on one side inner surface of the body 11 in such a manner as to be parallel to the body 11.

The insertion hole 13 is formed on the side portion of the body 11 in such a manner as to communicate with the interior of the body 11, and when the rack gear 12 is formed on the bottom surface of the interior of the body 11, the insertion hole 13 is desirably formed to allow portions of top and both side surfaces of the body 11 to be open.

The operating part 20 has the rotary shaft 21, the pinion gear 22 disposed on the outer peripheral surface of the rotary shaft 21 in such a manner as to correspond to the rack gear 12, and the moving piece 23 protruding outwardly from the outer peripheral surface of the rotary shaft 21.

The rotary shaft 21 is located at one side end of the operating part 20.

The pinion gear 22 is disposed on the outer peripheral surface of the rotary shaft 21 in such a manner as to correspond to the rack gear 12, and desirably, the pinion gear 22 is disposed on a quarter of the outer peripheral surface of the rotary shaft 21.

The moving piece 23 protrudes outwardly from the outer peripheral surface of the rotary shaft 21 toward the outside and is fixedly disposed on one side of a door.

The fixed part 10 and the operating part 20 are desirably made by means of injection molding using molds.

Further, the rotary shaft 21 of the operating part 20 is inserted into the insertion hole 13 of the fixed part 10, so that the rack gear 12 and the pinion gear 22 are engaged with each other and the moving piece 23 protrudes outwardly from the body 11.

Furthermore, bearings 30 are coupled in the interior of the body 11 by means of fastening bolts to the top and bottom ends of the rotary shaft 21, so that the bearings 30 are coupled to both ends of the rotary shaft 21 inserted into the interior of the body 11 through the insertion hole 13, thereby fixing the rotary shaft 21 thereto to prevent the rotary shaft 21 from being deviated from the interior of the body 11. In addition, the outer peripheral surfaces of the bearings 30 come into close contact with the top and side surfaces of the interior of the body 11, thereby guiding the rotary shaft 21 moving.

Also, the rotary shaft 21 has a through hole penetratedly formed thereon in such a manner as to allow the fastening bolts to be fastened thereto, and accordingly, the bearings 30 are fixed to the rotary shaft 21 together with washers by means of the fastening bolts. In this case, the bearings 30 are fixed to the rotary shaft 21 in such a manner as to allow the outer peripheral surfaces thereof to come into close contact with the inner surfaces of the body 11.

Further, desirably, covers for shielding the front and rear sides of the body 11 are additionally provided.

Hereinafter, an operating process of the door hinge according to the first embodiment of the present invention will be explained.

As shown in FIGS. 3 and 4, the rotary shaft 21 of the operating part 20 is inserted into the interior of the body 11 through the insertion hole 13, and in the state where the rack gear 12 and the pinion gear 22 are engaged with each other, accordingly, the rotary shaft 21 is fixed to the interior of the body 11 by means of the bearings 30. The pinion gear 22 is disposed on a quarter of the outer peripheral surface of the rotary shaft 21, desirably, on a third quarter of the outer peripheral surface of the rotary shaft 21.

If the moving piece 23 rotates in a counterclockwise direction around the rotary shaft 21, accordingly, the pinion gear 22 formed around the rotary shaft 21 is engaged with the rack gear 12 and thus moves from the left side to the right side. Because the pinion gear 22 is disposed on a quarter of the outer peripheral surface of the rotary shaft 21, at this time, the rotating radius of the moving piece 23 around the rotary shaft 21 is limited to an angle of 90°.

Moreover, as shown in FIGS. 5 and 6, a door hinge 200 according to a second embodiment of the present invention includes: a first fixed part 10a and a first operating part 20a disposed on one side end portion of a moving piece 23 and a second fixed part 10b and a second operating part 20b disposed on the other side end portion of the moving piece 23 in a symmetrical relation with the first fixed part 10a and the first operating part 20a, wherein the rotating radius of the second fixed part 10b disposed symmetrically with the first fixed part 10a is increased to an angle of 180°.

At this time, the pinion gear 22 of the first operating part 20a is disposed on a third quarter of the outer peripheral surface of the rotary shaft 21, and the pinion gear of the second operating part 20b disposed symmetrically with the first operating part 20a is desirably disposed on a fourth quarter of the outer peripheral surface of the rotary shaft 21.

Further, the moving piece 23 has a shape of ‘[’ capable of connecting the first fixed part 10a and the second fixed part 10b with each other and minimizing the outwardly protruding portion therefrom, and also, both side end portions of the moving piece 23 are desirably connected to the rotary shafts 21.

According to the door hinge under the above-mentioned configuration, if the right side portion of the first fixed part 10a is fixed to a door frame and the left side portion of the second fixed part 10b is fixed to a door, the door hinge 200 can be installed, while minimizing the outwardly protruding portion therefrom. When the door is closed, further, the door hinge is not protrudingly exposed to the outside, and when the door is open, the moving piece 23 rotates to move the rotary shaft 21, so that if the door protrudes toward the outside, the door hinge performs the function as a hinge.

Further, as shown in FIGS. 7 to 9, the door hinge 200 according to the second embodiment of the present invention is configured wherein the first operating part 20a inserted into the first fixed part 10a rotates to allow the moving piece 23 to rotate to an angle of 90°, and the pinion gear disposed on the second operating part 20b located on the other side end portion of the moving piece 23 is engaged with the rack gear of the second fixed part 10b to allow the second fixed part 10b to rotate to an angle of 90°, so that the second fixed part 10b is reversed to an angle of 180° from the initial position thereof, and the moving piece 23 and the second fixed part 10b rotate spaced apart from each other, without having any interference during their rotation.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### EXPLANATIONS ON REFERENCE NUMERALS IN THE DRAWING

100: door hinge

10: fixed part

11: body

12: rack gear

13: insertion hole

20: operating part

21: rotary shaft

22: pinion gear

23: moving piece

30: bearing

1. A door hinge comprising:
a fixed part 10 having a body 11 formed in an angular pipe shape of at least a triangle or more, a rack gear 12 disposed parallel to the body 11 on one side inner surface of the body 11, and an insertion hole 13 formed on the side portion of the body 11 in such a manner as to communicate with the interior of the body 11; and
an operating part 20 having a rotary shaft 21, a pinion gear 22 disposed on the outer peripheral surface of the rotary shaft 21 in such a manner as to correspond to the rack gear 12, and a moving piece 23 protruding outwardly from the outer peripheral surface of the rotary shaft 21,
wherein the rotary shaft 21 is inserted into the insertion hole 13 in such a manner as to allow the moving piece 23 to outwardly protrude from the door hinge, and the moving piece 23 rotates around the rotary shaft 21, so that the rotary shaft 21 moves along the rack gear 12.

2. The door hinge according to claim 1, wherein the pinion gear 22 is disposed on a quarter of the outer peripheral surface of the rotary shaft 21, so that the rotating radius of the moving piece 23 around the rotary shaft 21 is limited to an angle of 90°.

3. The door hinge according to claim 1, wherein bearings 30 are coupled in the interior of the body 11 to the top and bottom ends of the rotary shaft 21 so as to fix the rotary shaft 21 inserted into the interior of the body 11 through the insertion hole 13 to prevent the rotary shaft 21 from being deviated from the interior of the body 11 and so as to guide the rotary shaft 21 moving.

4. The door hinge according to claim 1, wherein another operating part and another fixed part are disposed on the other side end portion of the moving piece 23 in a symmetrical relation with the operating part 20 and the fixed part 10 disposed on one side end portion of the moving piece 23, so that the rotating radius of another fixed part disposed symmetrically with the fixed part 10 is increased.
